(19) United States
(12) Patent Application Publication
(10) Pub. No.: US 2003/0172131 A1
(43) Pub. Date: Sep. 11, 2003

(54) Method and system for subject video streaming

(76) Inventor: Yonghui Ao, Vancouver (CA)

Correspondence Address: SUGHRUE MION, PLLC, 2100 PENNSYLVANIA AVENUE, N.W., WASHINGTON, DC, 20037, US

(21) Appl. No.: 10/239,415

(22) PCT Filed: Mar. 23, 2001
(86) PCT No.: PCT/IB01/00680

(51) Int. Cl. H04N 7/173; G06F 15/16

(52) U.S. Cl. 709/219; 709/231; 725/86

(57) ABSTRACT

A client and server deliver and play subjective video content over the Internet or other network. Frame order, frame rate, and viewing parameters are solely determined by the viewer. A passive streaming protocol supports the operation of the subjective video streaming, in which the server plays a passive role, yielding the control of the entire streaming process to the client system. A scheduler at the client drives the streaming and controls the pace and order of video content downloading. Streaming policies effectively maximize utilization of remote multi-viewpoint image contents shared by multiple on-line viewers.

### CROSS REFERENCE TO RELATED APPLICATIONS.

This application claims the benefit of U.S. Provisional Application No. 60/191,721 filed Mar 24, 2000, the disclosure of which is herein incorporated by reference in its entirety.

This application is related to U.S. Provisional Application No. 60/191,754, filed Mar. 24, 2000 by Ping Liu, which will herein be referred to as the related application.

### BACKGROUND OF THE INVENTION.

1. Field of the invention

The invention relates in general to the field of interactive video communication, and more particularly to networked multi-viewpoint video streaming. This technology can be used for such interactive video applications as E-commerce, electronic catalog, digital museum, interactive education, entertainment and sports, and the like.

2. Description of Related Art

Since the invention of television, a typical video system has consisted of a video source (a live video camera or a recording apparatus), a display terminal, and a delivery means (optional if it is a local application) comprising a transmitter a channel and a receiver. We call this type of video technology the objective video, in the sense that the sequential content of the video clip is solely determined by what the camera is shooting at, and that the viewer at the display terminal has no control of the sequential order and the content of the video.

A typical characteristic of most objective videos is that the visual content is prepared from a single viewpoint. In recent years there have been many new approaches to producing multi-viewpoint videos. A multi-viewpoint video clip simultaneously captures a scene during a period of time, being it still or in motion, from multiple viewpoints. The result of this multi-viewpoint capturing is a bundle of correlated objective video threads. One example of such an apparatus is an Integrated Digital Dome (IDD) as described in the related application.

With multi-viewpoint video content, it is possible for a viewer to switch among different viewpoint and so to watch the event in the scene from different angles. Imagine a display terminal that is connected to a bundle of multi-viewpoint objective video threads. Imagine further that the content of this multi-viewpoint bundle is about a still scene in which there is no object motion, camera motion, nor changes in luminance condition. In other, words every objective video thread in the multi-viewpoint bundle contains a still image. In this case, a viewer can still produce a motion video on the display terminal by switching among different images from the bundle. This is a video sequence not produced by the content itself but by the viewer. The temporal order of each frame's occurrence in the video sequence and the duration for each frame to stay on the display screen are solely determined by the viewer at his/her will. We call this type of video the subjective video. In general, subjective video refers to those sequences of pictures where changes in subsequent frames are cause not by objective changes of the scene but by changes of camera parameters. A more general situation is the mixed objective and subjective video, which we call ISOVideo (integrated subjective and objective video).

A main difference between objective video and subjective video is that the content of an objective video sequence, once it is captured, is completely determined, whereas the content of a subjective video is determined by both the capturing process and by the viewing process. The content of a subjective video when it is captured and encoded is referred to as the still content of the subjective video, or the still subjective video. The content of a subjective video when it is being played at viewer's will is referred to as the dynamic content of the subjective video, or the dynamic subjective video.

The benefit of subjective video is that the end user plays an active role. He/she has the full control on how the content is viewed, through playing with parameters such as viewpoint and focus. This is especially useful when the user wants to fully inspect an interested object, like in the process of product visualization in E-commerce.

With such apparatuses as IDD, the still content of subjective video can be effectively produced. There are two general modes to view the subjective video: local mode and remote mode. In the local mode, the encoded still content of subjective video is stored with certain randomly accessible mass storage, say a CD-ROM. Then, upon request, a decoder is used to decode the still content into an uncompressed form. Finally, an interactive user-interface is needed that displays the content and allows the viewer to produce the dynamic subjective video. In this mode, one copy of still subjective video is dedicated to serve one viewer.

In the remote mode, the encoded still content of subjective video is stored with a server system such as a fast computer system. Upon request, this server system delivers the still subjective video to a plurality of remote display terminals via an interconnection network, such as an IP network. If the play process starts after the still content is completely downloaded, then the rest of the process is exactly the same as in the case of local mode. When the still content file size is too large to be transmitted via low-bandwidth connections in a tolerable amount of time, the download-and-play is not a practical solution. If the play process is partially overlapped in time with the transmission, so that the play process may start with a tolerable time lag after the download starts, we are dealing with a subjective video streaming which is the topic of this invention. In the remote mode (or specifically the streaming mode), one copy of still subjective video on the server serves a multiplicity of remote users, and one copy of still subjective video may yield many different and concurrent dynamic subjective video sequences.

It can be seen that the streaming mode shares many functional modules with the local mode, such as video decoding and display. Still, there are new challenges with the streaming mode, the main challenge being that not all of the still contents are available locally before the streaming process completes. In this case, not all of dynamic contents can be produced based on local still contents, and the display terminal has to send requests to the server for those still contents that are not available locally. The invention relates to a systematic solution that provides a protocol for controlling this streaming process, a user-interface that allows the viewer to produce the dynamic content, and a player that displays the dynamic subjective video content.

At present, there are mainly two types of video streaming technologies: single-viewpoint video streaming (or objective video streaming) and graphic streaming.

Objective video streaming

In single viewpoint video streaming (or objective video streaming), the content to be transmitted from server to client is a frame sequence made of single viewpoint video clips. These video clips are frame sequences pre-captured by camera recorder, or are computer generated. Typical examples of objective video streaming methods are real-time transport protocol (RTP) or real-time streaming protocol (RTSP), which provide end-to-end delivery services for data with real-time characteristics, such as interactive audio and video. During the streaming process, the objective video is transferred from server to client frame by frame. Certain frame can be. skipped in order to maintain the constant frame rate. The video play can start before the transmission finishes.

A main difference between RTP/RTSP and the invented subjective video streaming lies in the content: RTP/RTSP only handles sequential video frames taken from one viewpoint at one time, while subjective video streaming deals with pictures taken from a set of simultaneous cameras located in a 3D space.

Another difference is that RTP/RTSP is objective, which means the client plays a passive role. The frame order, frame rate, and viewpoint of the camera are hard coded at recording time, and the client has no freedom to view the frames in an arbitrary order or from an arbitrary viewing angle. In other words the server plays a dominating role. In subjective video, the end client has the control to choose viewpoint and displaying order. At recording time, multi-viewpoint pictures taken by the multi-cameras are stored on the server and the system lets the end user control the streaming behaviors. The server plays a passive role.

Graphic streaming

Typical examples of graphic streaming are MetaStream and Cult3D, two commercial software packages. In this approach there is a 3D graphics file pre-produced and stored on the server for streaming over the Internet. The file contains the 3D geometry shape and the textural description of an object. This 3D model can be created manually or semi-automatically. The streaming process in these two examples is not a true network streaming, since there is no streaming server 130 existent in the whole process. There is a client system which is usually a plug-in to an Internet browser and which downloads the graphics file and displays it while downloading is still in progress. After the whole 3D model is downloaded, the user can freely interact with the picture by operations such as rotation, pan and zoom in/out.

MetaStream, Cult3D, and the like deliver 3D picture of an object through a different approach from the invented method: the former is model based whereas the later is image based. For the model-based approaches, building the 3D model for a given object usually takes a lot of computation and man-hours, and does not always assure a solution. Also, for many items such as a teddy bear toy it is very hard or impossible to build a 3D model in a practical and efficient way. Even if a 3D model can be built, there is a significant visual and psychological gap for end viewers to accept the model as a faithful image of the original object.

### SUMMARY OF THE INVENTION

In a preferred embodiment of the invention, there is no 3D model involved in the entire process. All the pictures constituting the still content of the subjective video the are real images taken from a multiplicity of cameras from different viewpoints. A 3D model is a high level presentation the building of which requires analysis of the 3D shape of the object. In contrast, in the above-identified preferred embodiment of the invention, a strictly image processing approach is followed.

Given an object or scene, the file size of the pictorial description of it according to the invention is normally larger than in those model-based approaches. However, the difference in size does not represent a serious challenge for most of the equipment for today's Internet users. By means of the streaming technology according to the invention, the end user will not need to download the whole file in order to see the object. He/she is enabled to see the object from some viewpoints while the download for other viewpoints is taking place.

Apple Computers produced a technology called QTVR (QuickTime Virtual Reality). This technology can deal with multi-viewpoint and panoramic images. There are thus certain superficial similarities between the QTVR and the invented method. QTVR supports both model-based and image-based approaches. Even so, there are many differences between QTVR and the invented method. QTVR and its third party tools require authoring work such as stitching images taken from a multi-viewpoint. Such operations typically cause nonlinear distortions around the boundaries of the patches. Operations according to the invention, however, do not involve any stitching together of images from different viewpoints. QTVR does not have a streaming server 130, and so the user needs to download the whole video in order to view the object from different aspect. In the invented method, the streaming server 130 and client together provide a system of bandwidth-smart controls (like wave-front, scheduler, caching, etc.) that allow the client to play the subjective video while the download is still taking place.

### BRIEF DESCRIPTION OF DRAWINGS

FIG. 1 illustrates multi-viewpoint image capturing and coating.

FIG. 2 shows a file format for a still subjective video content, that is, a file in the video at will format.

FIG. 3 shows the content of an offset table roduced during the content production process and stored in the video at will file header.

FIG. 4 illustrates the basic steps involved in subjective video streaming according to the invention.

FIG. 5 is a state datagram to illustrate the lifecycle of a video at will session.

FIG. 6 is a logic diagram showing the operation of the server in synchronous mode.

FIG. 7 is a logic diagram showing the operation of the server in an asynchronous mode.

FIG. 8 shows the organization of the client system for subjective video streaming.

FIG. 9 shows the construction of a viewpoint map.

FIG. 10 is a logic diagram showing the operation of the client.

FIG. 11 is a logic diagram showing the operation of the scheduler.

FIGS. 12(a) and (b) are explanatory figures for explaining a wave-front model and the accommodation of a user's new center of interest.

FIG. 13 illustrates exemplary fields in a video at will request.

FIG. 14 shows basic operations which may be available according to various embodiments of the invention while playing a subjective video.

FIG. 15 is a logic diagram for illustrating the operation principle of an e-viewer controller.

FIG. 16 is a diagram for explaining different revolution speeds.

FIG. 17 is a diagram relating to the streaming of panoramic contents.

### DETAILED DESCRIPTION OF THE PREFERRED EMBODIMENTS

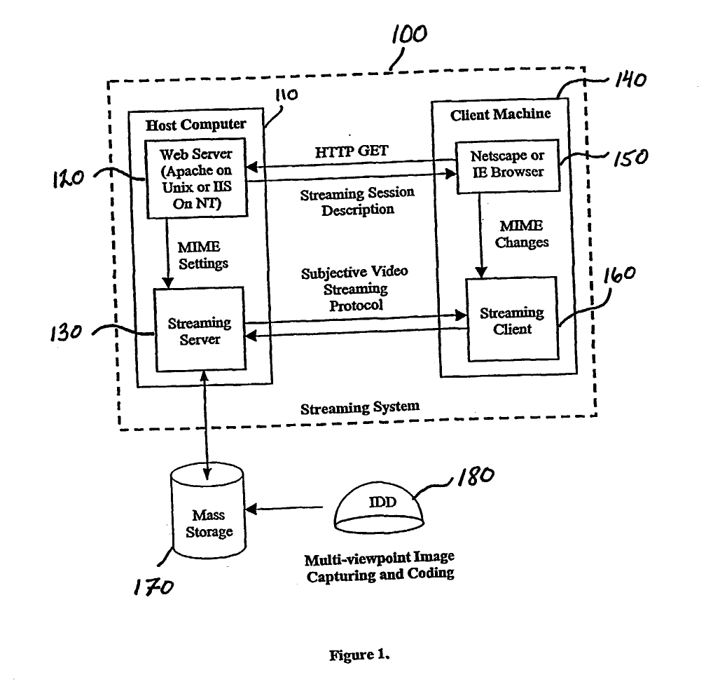

FIG. 1 illustrates the basic components of the invented subjective video streaming system 100 and its relation with the content production process. The content production procedure contains a multi-viewpoint image capturing step and a coding (compression) step. These two steps can be accomplished by means of an integrated device 180 such as the IDD described in the related application. The encoded data represents the still content of a subjective video and is stored on a mass storage 170 such as a disk that is further connected to the host computer 110 of the streaming system 100.

The subjective video streaming system 100 contains a streaming server 130 and a plurality of streaming clients 160 connected to the server 130 via an interconnection network, typically the Internet. The streaming server 130 is a software system that resides on a host computer 110. It is attached to a web server 120 (e.g., Apache on Unix or IIS on Windows NT). The web server 120 decides when to call the streaming server 130 to handle streaming-related request, via proper configurations such as MIME settings in the server environment.

The streaming client 160 is a software module resident on the client machine 140 that can be a personal computer or a Web TV set-top-box. It can be configured to work either independently or with Internet browsers such as Netscape or IE. In the latter case, the MIME settings in Netscape or IE should be configured so that the browser knows when the subjective video streaming functions should be launched.

Lower level transmission protocols such as TCP/IP and UDP are required to provide the basic connection and data package delivery functions. HTTP protocol is used for the browser to establish connection with the web server 120. Once the connection is set up, a streaming session is established and the subjective video streaming protocol takes over the control of the streaming process.

Vaw File

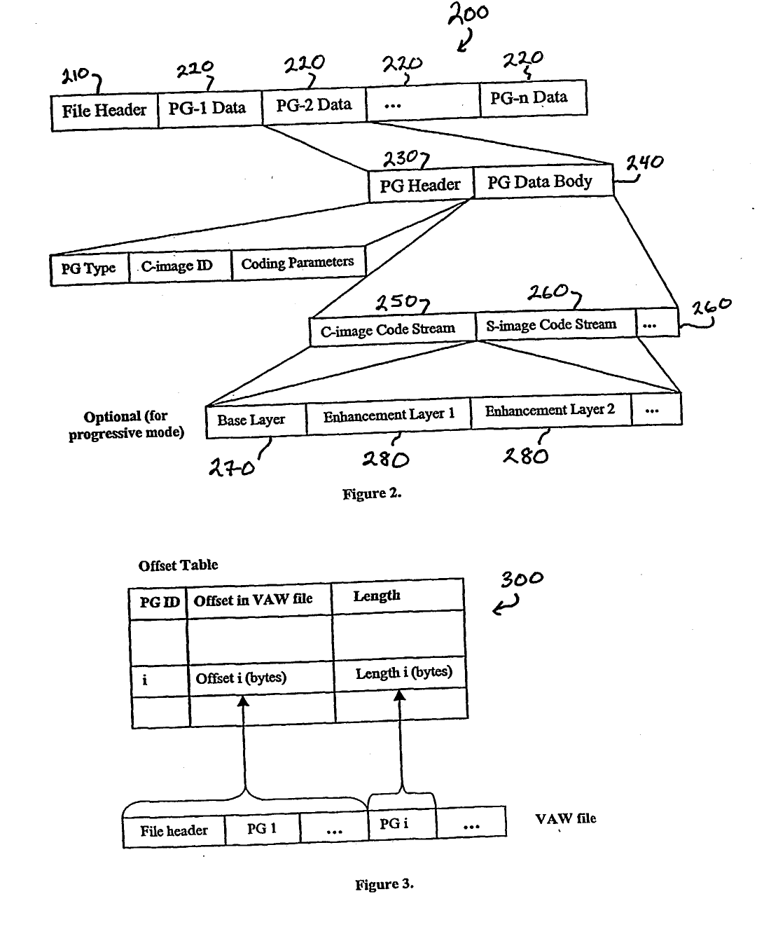

The subjective video streaming server 130 is connected with a mass storage device 170, usually a hard disk or laser disk. The still subjective video contents are stored on this storage device 170 in the unit of files. FIG. 2 shows the file format of a still subjective video content. For the rest of this paper this file format is referred to as VAW (Video At Will) file. In order to understand this file structure we need to review the construction principle of a capture and coding device 180, such as the IDD as described in the related application. A typical device 180 is a dome structure placed on a flat platform. On this dome hundreds of digital cameras are placed centripetally following a certain mosaic structure, acquiring simultaneous pictures from multiple viewpoints. While coding (compressing) these multi-viewpoint image data the device divides all viewpoints into processing groups (PGs). In each PG. there is a generally central viewpoint (C-image) and a set of (usually up to six) surrounding viewpoints (S-images). One IDD typically has 10-50 PGs.

The output from such a capturing and coding device may be seen in FIG. 2. At the top level of syntax, a VAW file 200 contains a file header 210 followed by the PG code streams 220. There is no particular preference for the order of the PGs within the code stream. The file header 200 contains generic information such as image dimensions, and an offset table 300 (see FIG. 3). A PG code stream 220 includes a PG header 230 and a PG data body 240. The PG header 230 specifies the type of PG (how many S-images it has), the C-image ID, and coding parameters such as the color format being used, what kind of coding scheme is used for this PG, and so on. Note that different PGs on the same IDD may be coded using different schemes, e.g., one using DCT coding and another using sub-band coding. It will be understood that there is no regulation on how to assign the C-image ID. Each PG data body 240 contains a C-image code stream 250 followed by up to six S-image code streams 260. No restriction is required on the order of those S-image code streams, and any preferred embodiment can have its own convention. Optionally, each S-image may also have an ID number.

Candidate coding schemes for compressing the C-image and S-images can be standard JPEG or proprietary techniques. If a progressive scheme is used, which is popular for sub-band image coding, the code stream of the C-image and/or S-images can further contain a base layer and a set of enhancement layers. The base layer contains information of the image at a coarse level, whereas the enhancement layers contain information at finer levels of resolution. Progressive coding is particularly suitable for low bit-rate transmission.

FIG. 3 shows the content of the offset table 300. This table is produced during the content production process and is stored in the VAW file header 210. It records the offset (in bytes) of the start of each PG code stream from the start of VAW file. It is important information for the server to fetch data from the VAW file 200 during the streaming process.

Origin PG

For every VAW file 200 there is a unique PG, called the origin. Its central image corresponds to a particular viewpoint among all possible viewpoints. The origin is the start point of a streaming process, and is client-independent. In other words, the origin provides the first image shown on a client's display for all clients who have asked for this VAW file. Different VAW files may have different origins, depending on the application. For on-line shopping applications, the origin could be the specific appearance of the product that the seller wants the buyer to see at the first glance.

Passive Streaming Principle

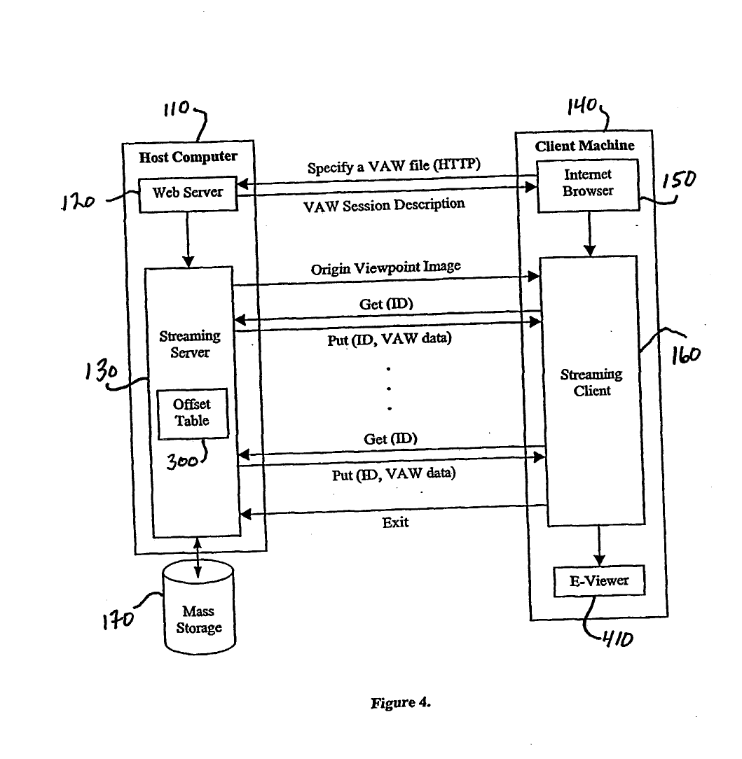

FIG. 4 illustrates the basic steps involved in the subjective video streaming. The basic idea is that the server 130 plays a passive role: whenever the client 160 wants a picture, the server retrieves it from the VAW file 200 and sends it to the client. The server will not send any command or request to the client, except image data. The client plays a dominating role: it controls the pace of streaming and commands the server on what data are to be transmitted. This is different from the case of objective video streaming where the server usually has the domination. This passive streaming principle helps dramatically simplifying the complexity of the server design, and therefore improves significantly the server capacity.

A subjective video streaming process according to an embodiment of the invention may operate as follows. The client 160 initiates the streaming process by sending a request to the server 130 via HTTP. By analyzing the request the server 130 determines which VAW file 200 the client 160 wants, and opens this VAW file 200 for streaming. The first batch of data sent from the server 130 to the client 160 includes the session description and the image data of the origin PG. Once a VAW file 200 is open, an offset table 300 is read from the file header 210 and stays in the memory to help in locating a requested PG. Then the server 130 waits until the next request comes. The client 160 keeps pushing the streaming by continuously submitting new GET requests for other PG data. In this process a scheduler 820 (not shown in FIG. 4) helps the client determine which PG is most wanted for the next step. The client passes the received data to an E-Viewer 410 for decoding and display. Whenever the client 160 wants to terminate the streaming, it sends an Exit request to the server and leaves the session.

Server

In a passive streaming process, the only thing that the server 130 needs to do is to listen to the incoming requests and prepare and put PG data to a communication buffer for delivery. The server 130 manages these tasks through running a set of VAW sessions.

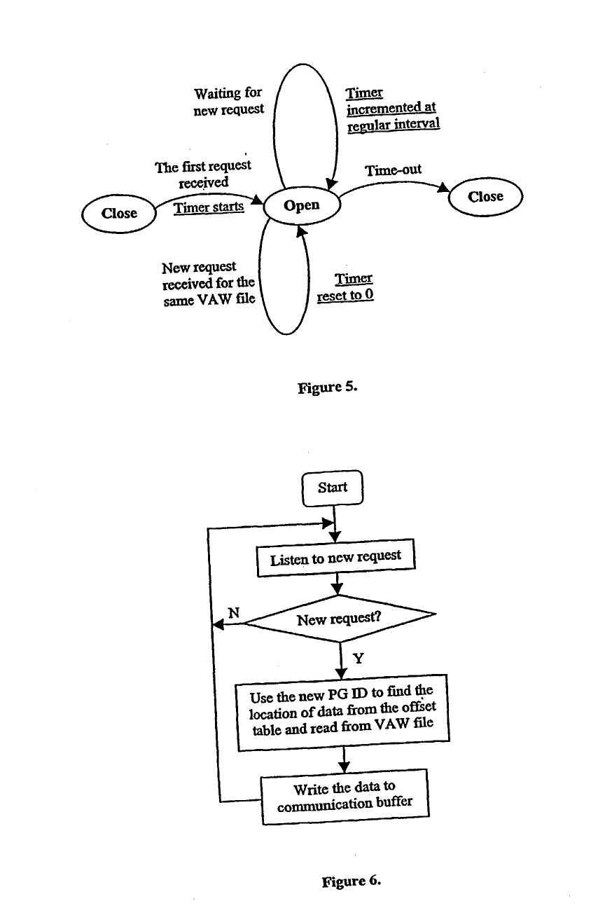

FIG. 5 illustrates the life cycle of a VAW session. Associated with each VAW session there is a VAW file 200 and an offset table 300. They have the same life cycle as the VAW session. When the server 130 receives the first request for a specific VAW file 200, it creates a new VAW Session, and opens the associated VAW file 200. From the header 210 of the VAW file 200 the offset table 300 is read into the memory. Multiple clients can share one VAW session. If a plurality of clients wants to access the same VAW file, then this VAW file is open only once when the first client comes. Accordingly, the associated offset table 300 is read and stays in the memory once the VAW file 200 is open. For any subsequent requests, the server will first check if the wanted VAW file 200 is already open. If yes then the new client simply joins the existing session. If not then a new session is created. There is a timer associated with each session. Its value is incremented by one after every predefined time interval. Whenever a new request to a session occurs no matter from which client, the server resets the associated time to zero. When the timer value reaches certain predefined threshold, a time-out signal is established which reminds the server to close the session and releases the offset table.

Whenever a new client joins a VAW session, the first data pack it receives is a session description, including information such as type of the data capture dome, picture resolution information, etc. All these information are found from the header 210 of the VAW file 200. The immediate next data pack contains the origin PG. For transmission. of the following data packs, there are two methods: synchronous mode and asynchronous mode.

FIG. 6 shows the control logic of server in synchronous mode. The basic idea of this mode is that the client 160 has to wait until the PG data for the last GET command is completely received, then it issues a new GET request. In this mode, the server does not verify whether the data for the last request has safely arrived at the client's end before it transmits a new pack. Therefore the workload of server is. minor: it simply listens to the communication module for new requests and sends out the data upon request.

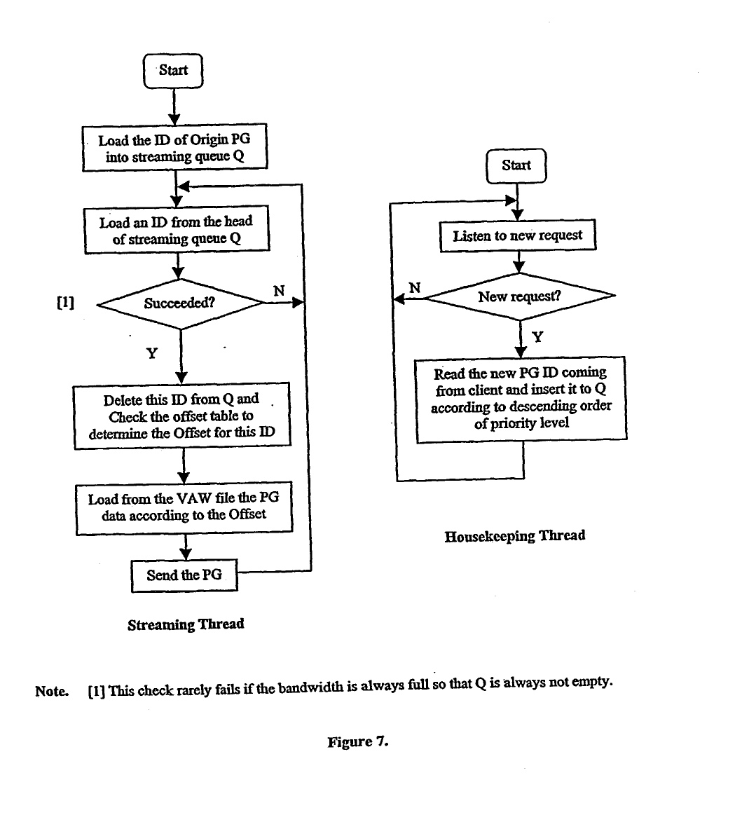

Data streaming in the asynchronous mode is faster than in synchronous mode, with additional workload for server (FIG. 7). In this mode, the client 160 will send a new request to the server 130 whenever a decision is made, and does not have to wait until the data for previous request(s) is completely received. To manage this operation the server sets up a streaming queue Q for each client, recording the PG tasks to be completed. For each new client, two control threads are created at the start of transmission. The streaming thread reads a PG ID at a time from the head of the queue and processes it, and the housekeeping thread listens to the incoming requests and updates the queue. In this mode, the incoming request contains not only a PG ID but also a priority level. The housekeeping thread inserts the new request to Q so that all PG IDs in Q are arranged according to the descending order of priority level. If several PGs have the same priority level, a FIFO (first in first out) policy is assumed.

Client System

FIG. 8 shows the organization of the client system 140 for subjective video streaming. Since the client system 140 plays a dominating role in passive streaming of still subjective video content, it has a more complicated organization than the server system 110. It includes a streaming client 160, an E-viewer 410, and a communication handler 150. The function of communication handler 150 is to deal with data transmission. In an embodiment this function is undertaken by an Internet browser such as Netscape or Internet Explorer. Accordingly, the E-Viewer 410 and the streaming client 160 are then realized as plug-ins to the chosen Internet browser. The task of the streaming client 160 is to submit data download requests to the server 130. The task of the E-viewer 410 is to decode the received image data and to provide a user interface for displaying the images and for the end user to play the subjective video.

The client system 140 is activated when the end-user issues (via an input device 880) the first request for a specific VAW file 200. This first request is usually issued through the user interface provided by the Internet browser 150. Upon this request, the streaming client 160 and the E-Viewer 410 are launched and the E-Viewer 410 takes over the user interface function.

Viewpoint Map

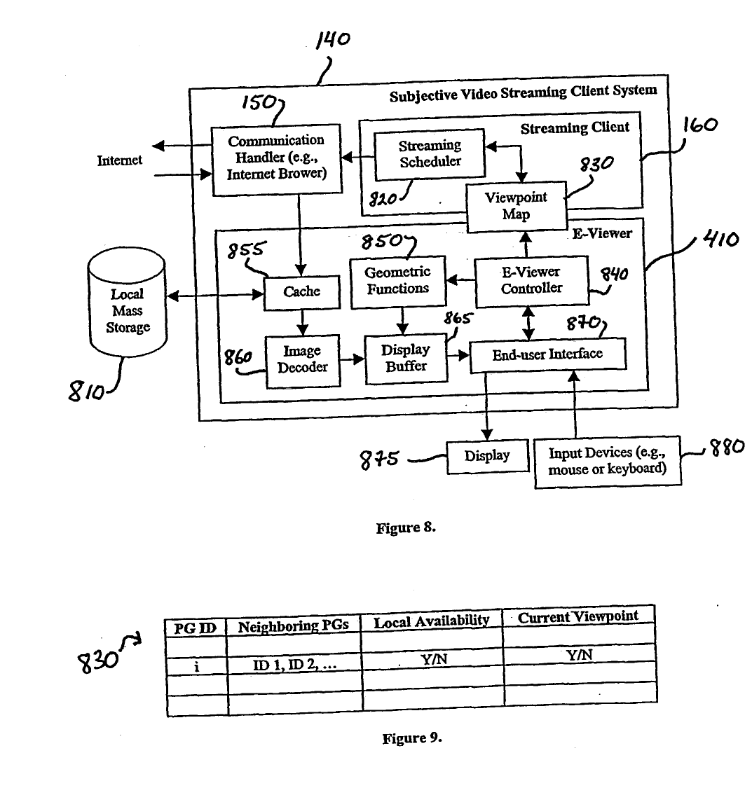

In this client system 140, there is an important data structure, the viewpoint map 830, shared by the streaming client 160 and the E-Viewer 410. FIG. 9 shows its construction. It has a table structure with four fields and is built by the streaming client 160 after the session description is received. This session description contains the configuration information of the viewpoints, which enables the streaming client 160 to initialize the viewpoint map 830 by filling the PG-ID and the Neighboring PG fields for all PGs. The Current Viewpoint field indicates whether any of the viewpoints in a PG, including C-viewpoint or S-viewpoint, is the current viewpoint. At any time or moment there is exactly one PG that has YES in its current viewpoint field. Initially all PGs are NOT the current viewpoint. Once the origin PG is received, its current viewpoint field is set to YES. The current PG is determined by the end-user, and is specified by the E-Viewer 410.

In non-progressive transmission, the local availability field indicates whether a PG is already completely downloaded from the server. In progressive transmission, this field indicates which base and/or enhancement layers of a PG have been downloaded. Initially the streaming client 160 marks all PGs as NO for this field. Once the data of a PG is completely received, the E-Viewer 410 will turn the corresponding PG entry in the viewpoint map 830 as YES (or will register the downloaded base or enhancement layer to this field in the case of progressive transmission).

Streaming Client

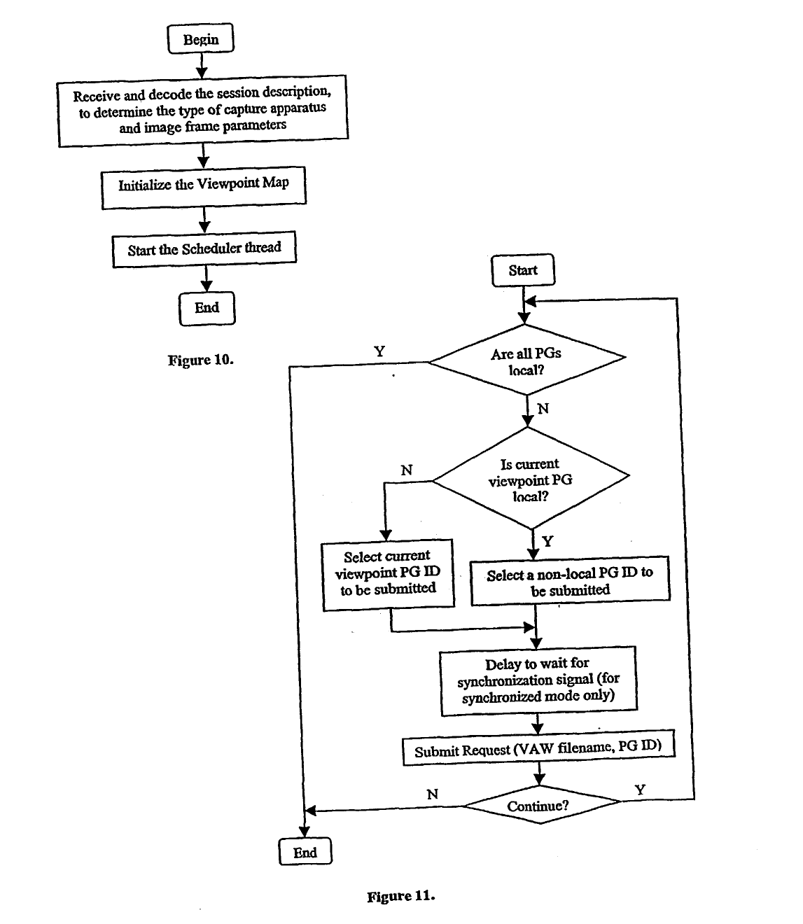

FIG. 10 illustrates the control logic of the streaming client 160. When it starts operating, the first VAW file 200 request has been submitted to the server 130 by the Internet browser 150. Therefore, the first thing that the streaming client 160 needs to do is to receive and decode the session description. Then, based on the session description, the viewpoint map 830 can be initialized. The streaming client 160 then enters a control routine referred to herein as the scheduler 820.

Scheduler

To some extent, the scheduler 820 is the heart that drives the entire subjective video streaming system. This is because that any complete interaction cycle between the server 130 and client 160 starts with a new request, and that except for the very first request on a specific VAW file 200, all subsequent requests are made by the scheduler 820.

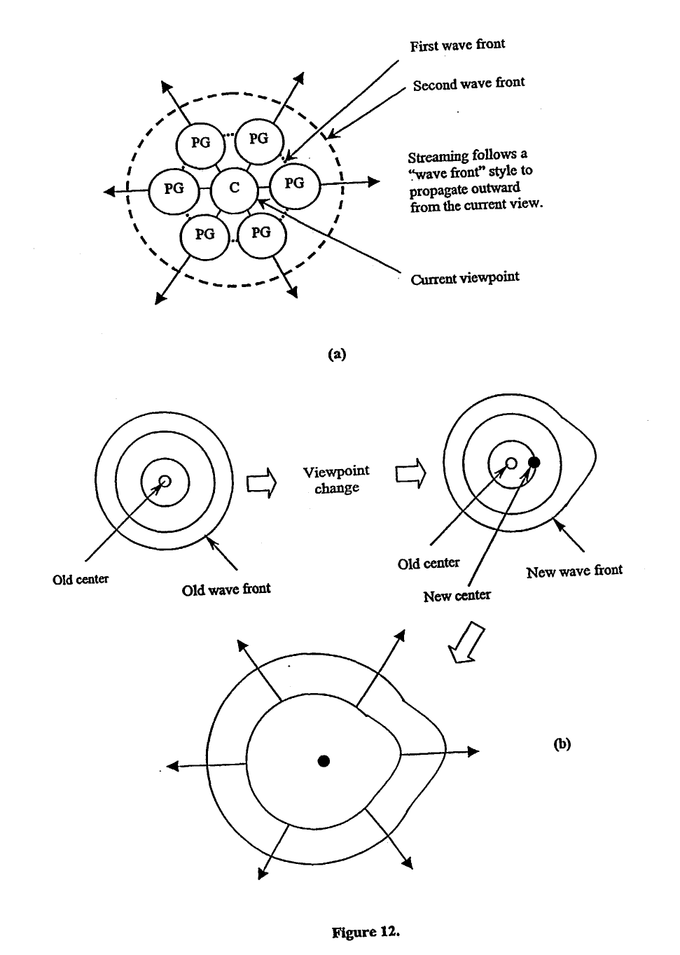

FIG. 11 shows the operation of the scheduler 820. Once activated, the scheduler 820 keeps looking at the viewpoint map 830 to select a PG ID for download at the next step. If all PGs are found already downloaded, or the end user wants to quit from the session, the scheduler 820 terminates its work. Otherwise, The scheduler 820 will select, from those non-local PGs, a PG that is believed to be most wanted by the end-user. There are different policies for the scheduler 820 to make such a prediction of the user's interest. In one embodiment a wave-front model is followed (see FIG. 12). If the PG that covers the current viewpoint is not local, it is processed with top priority.

In synchronous streaming mode, the client system 140 will wait for the completion of transmission of last data pack it requested before it submits a new request. In this case, when the scheduler 820 makes its choice for the new PG ID, it waits for the acknowledgement from the E-Viewer controller 840 about the completion of transmission. Then a new request is submitted. In asynchronous mode, there is no such a time delay. The scheduler 820 simply keeps submitting new requests. In practice, the submission process of new requests can not be too ahead of download process. A ceiling value is set that limits the maximum length of Q queue on the server. In an embodiment this value is chosen to be eight.

Wave-Front Model

FIG. 12 illustrates the principle of wave-front model. Maximum bandwidth utilization is an important concern in the subjective video streaming process. With limited bandwidth, the scheduling policy is designed to ensure that the most wanted PGs are downloaded with the highest priority. Since the “frame rate” and the frame order of a subjective video are not stationary and are changing at the viewer's will from time to time, the scheduler 820 will typically deal with the following two scenarios.

Scenario One: the viewer stares at a specific viewpoint and does not change viewpoint for a while. Intuitively, without knowing the user's intention for the next move, the scheduler 820 can only assume that the next intended move could be in all directions. This means that the PGs to be transmitted for the next batch are around the current PG, forming a circle with the current PG as the center. If all PG IDs on this circle are submitted, and the user still does not want to change viewpoint, the scheduler 820 will process the PGs on a larger circle. This leads to the so-called wave-front model (FIG. 12 (a)).

Scenario Two: a viewpoint change instruction is issued by E-Viewer 410. In this case, the shape of the wave front is changed to accommodate user's new center of interest (FIG. 12(b)). One can imagine that at the very initial stage of a streaming session, the shape of the wave front is a perfect circle with the origin PG as the center. Once the user starts playing the subjective video, the wave front is gradually deformed into an arbitrary shape.

Request Format

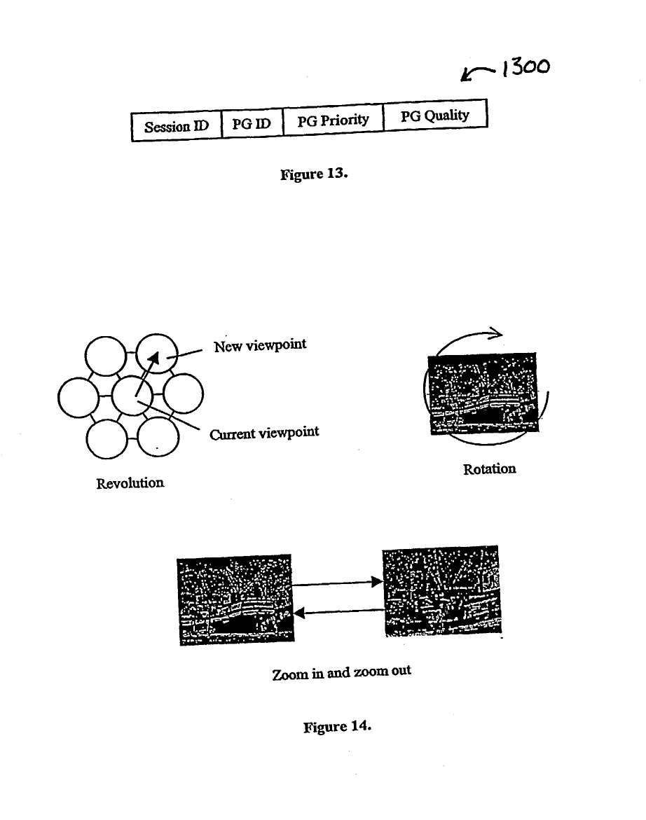

As shown in FIG. 13, a typical VAW request 1300 should include but is not restricted to the following fields:

Session ID: tells the server to which VAW session this current request is made.

PG ID: tells the server where the new viewpoint is.

PG Priority: tells the server the level of urgency this new PG is wanted.

PG Quality: if a progressive scheme is used, the PG quality factor specifies to which base or enhancement layer(s) the current request is made.

Playing Subjective Video

FIG. 14 shows three basic operations which may be available while playing a subjective video: revolution, rotation, and zoom. Revolution is defined as a sequence of viewpoint change operations. A rotation operation happens at the same viewpoint with X-Y coordinates rotating within the image plane. Zooms, including zoom-in and zoom-out, are scaling operations also acting on the same viewpoint.

In an embodiment, the rotation is considered as an entirely local function, whereas the revolution and zoom require support from the server. The rotation is realized by a rotational geometric transform that brings the original image to the rotated image. This is a standard mathematical operation and so its description is omitted for the sake of clarity. The zoom operations are realized by combining sub-band coding and interpolation techniques, which are also known to one familiar with this field. During the zoom operations, if some of the enhancement layer data is not available locally, a request is submitted,for the same VAW session, same PG ID, but for more enhancement layers, and this request is to be dealt with by the server 130 with the highest priority. Revolution corresponds to a sequence of viewpoint changes. Its treatment is described below.

E-Veiwer

The functional components of the E-Viewer appear, in very simplified form, in FIG. 8. There are four major function modules: the E-Viewer controller 840, the geometric functions 850, the image decoder 860, and the end-user interface 870. The E-Viewer 410 is a central processor that commands and controls the operation of the other modules. The geometric functions 850 provide necessary computations for rotation and zooming operations. The image decoder 860 reconstructs images from their compressed form. The end-user interface 870 provides display support and relays and interprets the end-user's operations during the playing of subjective video.

There are three data structures that the E-Viewer 410 uses to implement its functions: the cache 855, the display buffer 865, and the viewpoint map 830. The cache holds compressed image data downloaded from the server. Depending on the size of cache 855, it may hold the whole still subjective contents (in compressed form) for a VAW session, or,only part of it. More PG data that exceeds the capacity of cache 855 can be stored in a mass storage device 810 such as a disk. The display buffer 865 holds reconstructed image data to be sent to display 875. The viewpoint map 830 is used by both the E-Viewer controller 840 and the Scheduler 820. Whenever a data pack is received, the E-Viewer 410 updates the status of the Local Availability field for the corresponding PG in the viewpoint map 830.

The cache 855 plays an important role in the subjective video streaming process. After one picture is decoded and displayed, it will not be discarded just in case the end-user will revisit this viewpoint in the future. However, keeping all the pictures in the decoded form in memory is expensive. The cache 855 will keep all the downloaded pictures in their compressed form in memory. Whenever a picture is revisited, the E-Viewer 410 simply decodes it again and displays it. Note that we are assuming that the decoding process is fast, which is true for most modern systems.

The decoding process is a process opposite to the encoding process that forms the VAW data. The data input to the decoder 860 may be either from the remote server 130 (via Internet) or from a local disk 810 file. However, the decoder 860 does not differentiate the source of data, it simply decodes the compressed data into raw form.

E-Viewer Controller

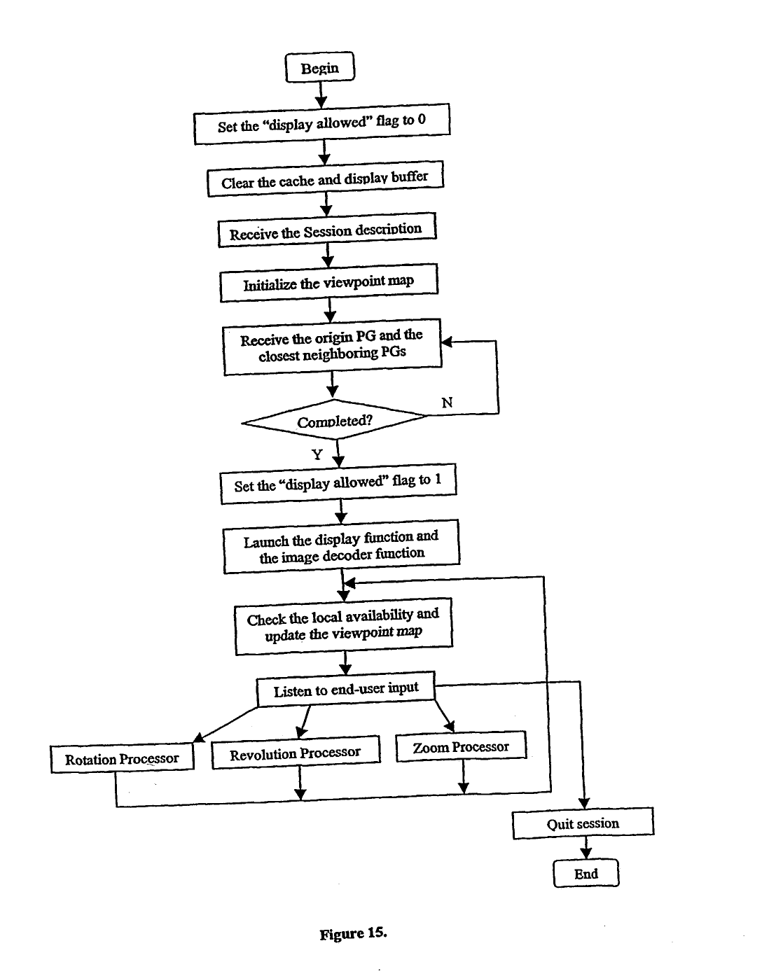

FIG. 15 illustrates the operation principle of the E-Viewer controller 840.

At the very beginning, the E-Viewer 410 is launched by the first request on a new VAW session through the Internet browser 150. The display 875 is initially disabled so that the display window will be blank. This is a period when the E-Viewer 410 waits for the first batch of data to come from the server 130. The E-Viewer 410 will prompt a message to inform the end-user that it is buffering data. In an embodiment, during this period, the origin PG and its surrounding PGs are downloaded.

During this initialization stage the E-Viewer 410 controller will also clear the cache 855 and display buffer 865. Once the session description is received, the controller 840 will initialize the viewpoint map 830 based on the received information. All the PGs will be marked non-local initially, and the current viewpoint pointer is at the origin viewpoint. (Given this information the scheduler 820 can start its job.)

Once the first batch of data packs is received, the display will be enabled so that the end user will see the picture of the origin viewpoint on the screen 875. Then the controller 840 enters a loop. In this loop, the controller 840 deals with the user input and updates the viewpoint map 830. In synchronous transmission mode, upon completion of a data pack, the controller will issue a synchronization signal to scheduler 820 so that the scheduler 820 can submit a new request.

The E-Viewer 410 preferably provides four commands for the end user to use in playing the subjective video: revolution, rotation, zoom, and stop. For each of these commands there is a processor to manage the work. In the revolution mode, the processor takes the new location of the wanted viewpoint specified by the user through an input device 880 such as a mouse. Then it finds for this wanted viewpoint an actual viewpoint from the viewpoint map 830, and marks it as the new current viewpoint. In the rotation mode, the controller calls the geometric functions 850 and applies them to the image at the current viewpoint. The rotation operation can be combined with the revolution operation.

If a stop command is received, the controller 840 will release all data structures initially opened by it, kill all launched control tasks, and close the E-Viewer display window.

Scalable Transmission

In order to support different applications with different network bandwidth, the scheduler 820 and the E-Viewer controller 840 can be programmed to achieve the following progressive transmission schemes to be used with the various embodiments.

Resolution Scalability

As described above, when the still content of a subjective video is produced, the image information can be encoded and organized as one base layer 270 (see FIG. 2) and several enhancement layers 280. If a user is using a fast Internet connection, he/she may ask for a session with a big image and more details. He/she would choose a smaller frame size if the Internet access is via a slow dialup.

Resolution scalability can also be used in an alternative way. Since the scheduler 820 can specify the quality layers it wants when submits a quest, it can be easily programmed such that, for all viewpoints being visited for the first time, only the base layer data is downloaded. Then, whenever the viewpoint is revisited, more layers are downloaded. This configuration allows the coarse information about the scene to be downloaded at a fast speed, and provides a visual effect of progressive refinement as the viewer revolves the video. This configuration is, bandwidth-smart and also it fits the visual psychology: the more a user revisits a specific viewpoint (which could highly reflect his/her interest in that viewpoint), the better the image quality is for that viewpoint.

Viewpoint Scalability

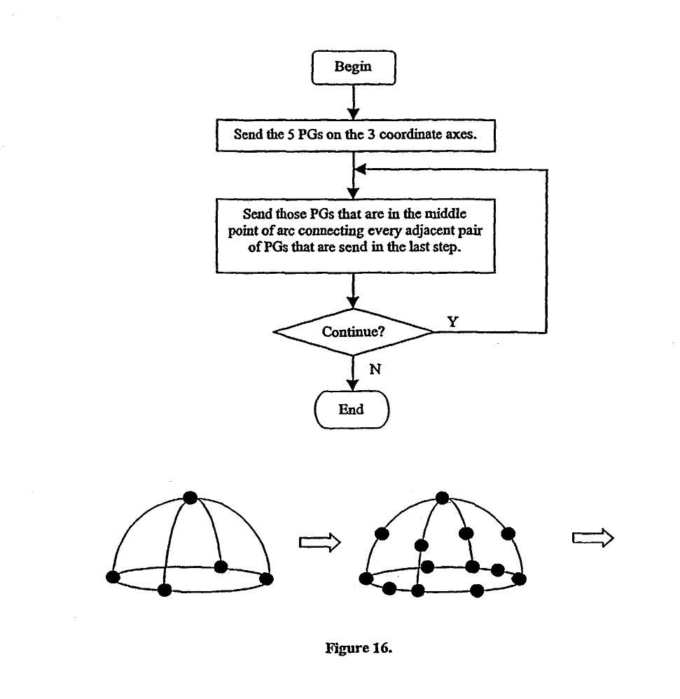

For the user with slow Internet access, he/she can skip several viewpoints during the revolution. This is referred to as the fast revolution in subjective video. One extreme case is that only five PGs at five special viewpoints are downloaded for the first batch of data packs for transmission. With these PGs, the user can at least navigate among the five orthogonal viewpoints. Then, as the download process evolves, more PGs in between the existing local PGs will be available, so that the operation of revolution will become smoother (FIG. 16).

Another possible realization of viewpoint scalability is to download only the C-image of each PG first. After all C-images of all PGs are completed, the S-images are then downloaded.

Local Playback Compatibility

Locally stored VAW files 200 may be replayed from disk 810.

Streaming Panoramic Contents

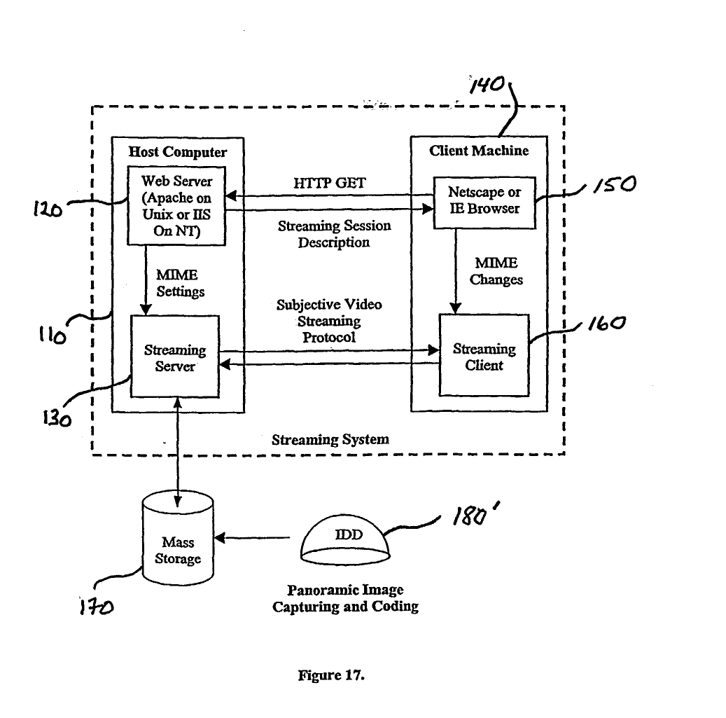

FIG. 17 shows that the described subjective video streaming methods and system are also applicable to streaming panoramic contents.

Panoramic image contents give viewer the visual experience that he/she is completely immersed in a visual atmosphere. Panoramic content is produced by collecting the pictures taken at a single viewpoint towards all possible directions. If there is no optical change in visual atmosphere during the time the pictures are taken, then the panoramic content forms a “spherical still image”. Viewing this panoramic content corresponds to moving around a peeking window on the sphere. It can be readily understood that viewing a panoramic content is a special subjective video playing process, and that panoramic content is just the other extreme in contrast to multi-viewpoint content.

In observing this relationship, it is claimed here that the invented subjective video streaming methods and system can be directly applied to panoramic contents without substantial modification. The only major change to be done is to simply turn all lenses of the multi-viewpoint capturing device 810′ from pointing inwards to outwards.

Conclusion

It will be apparent to those skilled in the art that various modifications can be made without departing from the scope or spirit of the invention, and it is intended that the present invention cover such modifications and variations in accordance with the scope of the appended claims and their equivalents.

There is claimed:

1. A method of supporting subjective video at a server, comprising:
receiving a request relating to subjective video content;
accessing a view at will file corresponding to said subjective video content;
in response to said request relating to said subjective video content, providing initial image data relating to an origin processing group of said view at will file;
receiving a subsequent request relating to said subjective video content;
determining, from said subsequent request, a processing group identifier; and
based on said processing group identifier, providing subsequent image data relating to a processing group identified by said processing group identifier;
wherein said initial image data and said subsequent image data comprise coded image data not derived from a three-dimensional model.

2. The method of supporting subjective video at a server as set forth in claim 1, further comprising, after said accessing of said view at will file, obtaining from said view at will file an offset table, wherein said offset table indicates a start of each set of image data relating to each processing group in said view at will file.

3. The method of supporting subjective video at a server as set forth in claim 2, wherein said view at will file comprises:
a file header and processing group code streams;
said file header comprising said offset table;
each of said processing group code streams comprising:
a respective processing group header indicating a processing group, and identifier relating to a control camera in said processing group, and coding parameters; and
a processing group data body, comprising:
a code stream relating to an image provided by said control camera, defining a C-image; and
code streams relating to images provided by each of a plurality of surrounding cameras in said processing group, defining S-images.

4. The method of supporting subjective video at a server as set forth in claim 3, wherein said code streams relating to said C-image and said S-images further comprise a base layer and a set of enhancement layers, said base layer containing information of said image data at a coarse level, and said enhancement layers containing information at finer levels of resolution.

5. A method of supporting subjective video at a. client, comprising:
initiating a streaming process by sending a request relating to subjective video content;
receiving initial image data relating to an origin processing group of said view at will file;
sending a subsequent request relating to a different processing group with respect to said subjective video content;
receiving subsequent image data relating to said different processing group;
wherein said initial image data and said subsequent image data comprise coded image data not derived from a three-dimensional model.

6. The method of supporting subjective video at said client as set forth in claim 5, further comprising:
providing said client with a streaming client and a viewer, said streaming client including a streaming scheduler, said viewer including a viewer controller, a display buffer, an end-user interface, a cache, and an image decoder;
providing said client with a viewpoint map, shared by said streaming client and said viewer;
receiving, in accordance with said initial image data, session description information; and
initializing said viewpoint map based on said session description information;
wherein:
said sending of said initial request activates said streaming scheduler;
said sending of said subsequent request is performed by said streaming scheduler;
said streaming scheduler identifies a selected processing group identifier based on user input;
said streaming scheduler updates said viewpoint map based on said received image data to indicate local availability with respect to image data on a processing group basis;
under control of said viewer controller:
said cache receives said image data in a compressed form;
said image decoder decodes said image data in said compressed form to provide decoded image data; and
said end-user interface receives said coded image data from said display buffer for display.

7. The method of supporting subjective video at said client as set forth in claim 6, wherein said viewer further comprises a geometric functions module for supporting user manipulation operations.

8. The method of supporting subjective video at said client as set forth in claim. 7, wherein said user manipulation operations include zoom, rotation, and revolution.

9. The method of supporting subjective video at said client as set forth in claim 8, wherein said rotation is performed as a solely local function, using a two-dimensional image plane, at said client without support from a server.

10. The method of supporting subjective video at said client as set forth in claim 8, wherein said zoom is performed as a function using support from said client and a remote server using resolution re-scaling operations.

11. The method of supporting subjective video at said client as set forth in claim 5, wherein said steps of sending said subsequent request and receiving said subsequent image data are performed in a synchronous manner.

12. The method of supporting subjective video at said client as set forth in claim 5, wherein said steps of sending said subsequent request and receiving said subsequent image data are performed in an asynchronous manner.

13. The method of supporting subjective video at said client as set forth in claim 6, wherein said streaming scheduler streams image data according to a wave-front model.

14. The method of supporting subjective video at said client as set forth in claim 13, wherein said wave-front model comprises:
when a change of viewpoint is not indicated by a user, s said streaming scheduler requests image data relating to processing groups in proximity to a present processing group, and
when a change of viewpoint is indicated by said user, said streaming scheduler requests image data relating to a processing group at said viewpoint and also processing groups in proximity thereto.

15. The method of supporting subjective video at said client as set forth in claim 13, wherein said wave-front model comprises arranging the order of image download based on the priority of a download task being inversely proportional to a distance between a current viewpoint and a viewpoint where said download task is defined.

16. The method of supporting subjective video at said client as set forth in claim 6, wherein said streaming scheduler streams image data according to a resolution scalability scheduling policy.

17. The method of supporting subjective video at said client as set forth in claim. 16, wherein said resolution scalability scheduling policy comprises:
determining a bandwidth of a local communication connection;
requesting one or more enhancement layers based on said bandwidth determination.

18. The method of supporting subjective video at said client as set forth in claim 16, wherein said resolution scalability scheduling policy comprises initially downloading only a base layer of said image data relating to a given viewpoint, monitoring user interaction to determine whether said given viewpoint is revisited, and, when said monitoring indicates that said given viewpoint is revisited, downloading one or more enhancement layers.

19. The method of supporting subjective video at said client as set forth in claim 8, wherein, in response to an indication of said revolution operation, said streaming scheduler streams image data by skipping processing groups in accordance with an indicated speed of rotation.

20. The method of supporting subjective video at said client as set forth in claim 6, further comprising storing downloaded compressed image data locally and, in response to a request for re-displaying said locally stored downloaded compressed image data, performing the steps of loading said locally stored downloaded compressed image data into said cache; decoding said locally stored downloaded compressed image data with said image decoder to provide said decoded image data; and providing said decoded image data to said end-user interface via said display buffer for display.

21. The method of supporting subjective video at said client as set forth in claim 5, wherein said image data is panoramic image data.

22. The method of supporting subjective video at said client as set forth in claim 5, wherein said image data is multi-viewpoint image data.

23. The method of supporting subjective video at said client as set forth in claim 5, wherein said viewer and said streaming client are implemented as plug-ins to a browser.

24. An interactive multi-viewpoint subjective video streaming system, comprising a client and a passive streaming server, said client providing to said server selection commands selecting from a plurality of viewpoints relating to a given scene, said server responding to said commands of said client by providing to said client corresponding image data for said selected one of said plurality of viewpoints.
